(19) United States
(12) Patent Application Publication
(10) Pub. No.: US 2014/0060669 A1
(43) Pub. Date: Mar. 6, 2014

(54) Buckle-connecting multifunctional decorative board

(71) Applicant: Zhaojun Guo, Shanghai (CN)

(72) Inventor: Zhaojun Guo, Shanghai (CN)

(21) Appl. No.: 14/085,054

(22) Filed: Nov. 20, 2013

Related U.S. Application Data
(63) Continuation-in-part of application No. 12/408,693, filed on Mar. 21, 2009, now abandoned.

(51) Int. Cl. F16L 3/08

(52) U.S. Cl. CPC F16L 3/08
USPC 137/362

(57) ABSTRACT

A buckle-connecting multifunctional decorative board, which can be applied on indoor ground, outdoor roof, or walls, comprises buckles provided at two sides thereof, and a tube-like chamber. The buckles simplify assembling of the decorative boards. The tube-like chamber receives a pipe or a cable. Therefore, a plurality of assembling operations can be finished at once to save construction time. The buckle-connecting multifunctional decorative board has functions of adjusting indoor temperature, receiving the pipe, melting snow on the roof, and heating water. The buckle-connecting multifunctional decorative board can be applied widely.

### BACKGROUND OF THE PRESENT INVENTION

1. Field of Invention

The present invention relates to a multifunctional decorative board, and more particularly to stone material for ground or a ceramic tile.

2. Description of Related Arts

The present invention provides a multifunctional decorative board. The process of paving flooring usually conflicts with the process of paving heating or cooling pipes. The pipes are usually damaged by correlative operations, and the layer of heating or cooling pipes often occupies a large height. In this way, the energy will be transmitted twice, which causes a long heating time, serious lag of warming, long working time, and large energy loss. In addition, conventional process of paving flooring is complex, and has serious problems of long construction period, poor construction quality, and waste of materials.

To solve the above problems, it is necessary to develop a new decorative board, to simplify the construction process. The decorative board is integrated with the heating or cooling pipes to increase construction efficiency of architecture decoration and construction quality. The new decorative board is manufactured by composite technology. The surface layer of the decorative board is made of rare natural material, and the bottom layer is made of synthetic board. Therefore, the decorative board has light weight and appropriate thickness, and is easy to manufacture and transport. The decorative board saves natural resources.

### SUMMARY OF THE PRESENT INVENTION

An object of the present invention is to provide a buckle-connecting multifunctional decorative board. A decorative board body is assembled with pipes via buckles, in such a manner that assembly and disassembly become easier, and efficiency of floor heating or cooling is increased. The buckle-connecting multifunctional decorative board has chambers for receiving pipes, and takes the place of conventional raised floor.

When the buckle-connecting multifunctional decorative board is used on outdoor roof, heating pipes are received in the chambers. When the outdoor roof is covered by accumulated snow, hot media is injected into the pipes to melt the accumulated snow. Conversely, when the buckle-connecting multifunctional decorative board on the roof is heated by summer sunlight, cold water is injected into the pipes, in such a manner that the roof is cooled and the water is heated. The heated water can be used in daily life. The buckle-connecting multifunctional decorative board has wide application.

Accordingly, in order to accomplish the above objects, the present invention provides a buckle-connecting multifunctional decorative board, comprising a decorative board body, an A connecting end, a B connecting end, a pipe chamber, a pipe. The A connecting end and the B connecting end are respectively provided on two sides of the decorative board body. A pair of embedding tenon and embedding groove, first and second horizontal position limiting buckles, first and second receiving grooves is provided at the connecting ends. The first and second receiving grooves has longitudinal openings matching with each other, in such a manner that the first and second receiving grooves cooperatively define a receiving chamber for receiving the pipe, after the decorative boards are assembled. The embedding tenon is convex in general, and the embedding groove is concave in general. The embedding tenon and embedding groove engage to prevent the decorative board from move up and down. The first and second horizontal position limiting buckles are respectively concave and convex. The first and second horizontal position limiting buckles respectively have side walls which are inclined, in such a manner that the first horizontal position limiting buckle enters the second horizontal position limiting buckle conveniently at a certain angle. Each of the first and second horizontal position limiting buckles has a leading cambered surface, in such a manner that the first and second horizontal position limiting buckles engage smoothly, and the first and second horizontal position limiting buckles will not be damaged by extrusion force between the side walls when disassembling. In addition, the first and second horizontal position limiting buckles control height of assembling, and assembling accuracy is guaranteed. The opening of the first receiving groove is upward, and the opening of the second receiving groove is downward. The first and second receiving grooves have sections in shape of arc, the arc of the first receiving groove is longer than the arc of the second receiving groove, in such a manner that the pipe can be received in the first receiving groove in advance, and assembly will not be disturbed by the pipe which is curving and out of the first receiving groove. The first and second receiving grooves are usually not too big, otherwise, heat conduction rate will be decreased. Therefore, it is difficult to pass the whole pipe through the first and second receiving grooves. In this way, the decorative boards engage with each other tightly without other elements. The pipe is received in the first and second receiving grooves provided inside the decorative board, so thickness of paving is reduced.

Another object of the present invention is to provide a buckle-connecting multifunctional decorative board, comprising a pair of locking elements provided at two sides of the buckle-connecting multifunctional decorative board. The locking elements are connected with the buckle-connecting multifunctional decorative board to form a whole. The locking elements are for locating the buckle-connecting multifunctional decorative board to avoid deviation of inclination angle, in such a manner that each of the buckle-connecting multifunctional decorative boards is installed in a same height.

Another object of the present invention is to provided a buckle-connecting multifunctional decorative board, which has a simple structure and low cost.

In order to attain the above objects, the present invention provides a buckle-connecting multifunctional decorative board, comprising:

a decorative board body;

first and second receiving grooves having longitudinal openings, provided at said two sides of said decorative board body; longitudinal connectors provided at two sides of the buckle-connecting multifunctional decorative board;

a pipe or a cable, wherein said pipe is used as or comprises a heating element, a cooling element, and the cable is a power transmitting element or a signal transmitting element; and

two connecting ends, provided at two sides of the buckle-connecting multifunctional decorative board, wherein first and second receiving grooves having longitudinal openings are provided at the connecting ends, the first and second receiving grooves match with each other, in such a manner that the first and second receiving grooves cooperatively define a receiving chamber for receiving the pipe, the pipe contact with the decorative board body, energy is transmitted from the pipe to the decorative board, in such a manner that temperature of the decorative board is changed effectively.

The connecting ends have a pair of mutual inserting elements, wherein the mutual inserting elements comprises a groove locking element and a tenon locking element, the locking elements have first and second horizontal locating planes, when the groove locking element engages with the tenon locking element, the pipe and the decorative board are connected as a whole tightly, the locking elements control height and angle of assembling of the decorative board to guarantee that each of the buckle-connecting multifunctional decorative boards is installed in a same height.

The first and second receiving grooves have sections in shape of arc, the arc of the first receiving groove is longer than the arc of the second receiving groove, in such a manner that the pipe can be received in the first receiving groove in advance, and assembly will not be disturbed by the pipe which is curving and out of the first receiving groove.

The second receiving groove has at least one extending concave provided at one side of the second receiving groove. Thus, when the decorative board is assembled in a certain angle, the extending concave spares space for adjusting vertical position of the decorative board, to avoid collision between the decorative boards, and simplify assembling of the decorative boards.

If the pipe provided in the decorative board is used as the heating element or the cooling element, the pipe is able to change the temperature of the decorative board. The pipe also can receive the power transmitting element or the signal transmitting element, and the application of the decorative board is widened.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a ground heating flooring with internal heat conduction structure according to a preferred embodiment of the present invention.

FIG. 2 is a local section of the ground heating flooring with internal heat conduction structure according to the above preferred embodiment of the present invention.

FIG. 3 is a schematic diagram of installing at a side of the ground heating flooring with internal heat conduction structure according to the above preferred embodiment of the present invention.

FIG. 4 is an alternative mode of the upper and lower F-shaped locking members of the ground heating flooring with internal heat conduction structure according to the above preferred embodiment of the present invention.

FIG. 5 is a perspective view of buckle-connecting multifunctional decorative boards according to a first preferred embodiment of the present invention.

FIG. 6 is a sectional view of the buckle-connecting multifunctional decorative boards according to the first preferred embodiment of the present invention.

FIG. 7 is a sectional view of the buckle-connecting multifunctional decorative boards according to a second preferred embodiment of the present invention.

FIG. 8 is a sectional view of the buckle-connecting multifunctional decorative boards according to a third preferred embodiment of the present invention.

FIG. 9 is a sectional view of the buckle-connecting multifunctional decorative boards according to a fourth preferred embodiment of the present invention.

FIG. 10 is a sectional view of the buckle-connecting multifunctional decorative boards according to a fifth preferred embodiment of the present invention.

### DETAILED DESCRIPTION OF THE PREFERRED EMBODIMENT

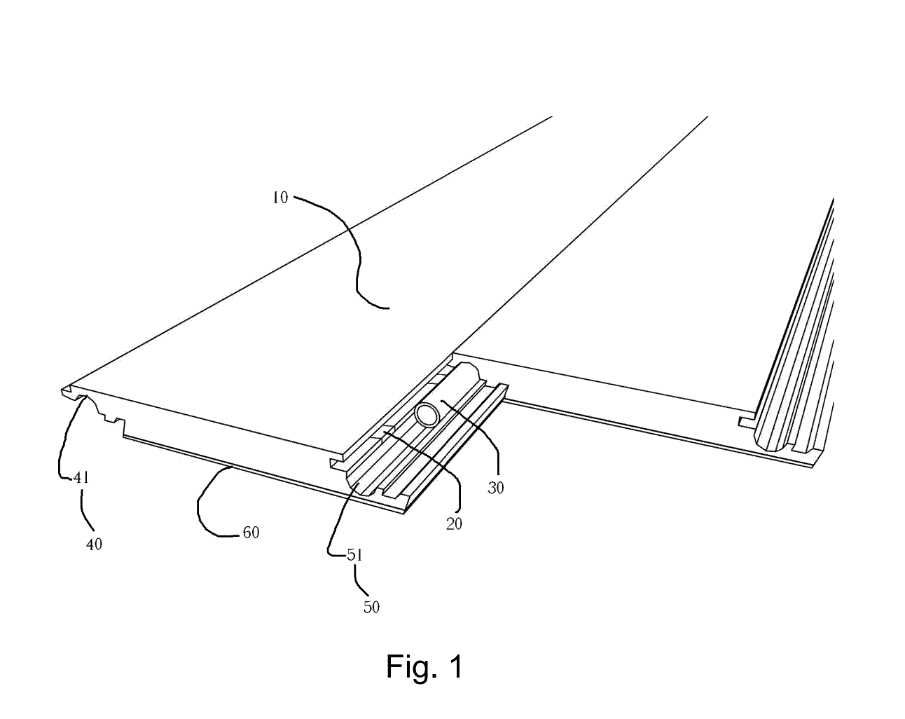

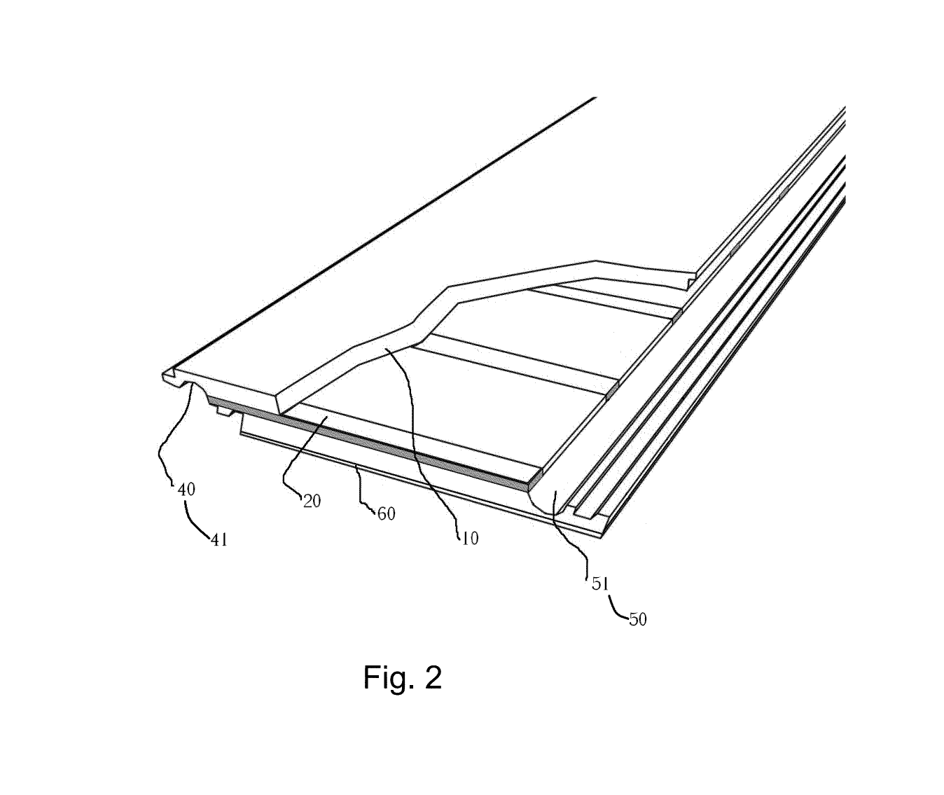

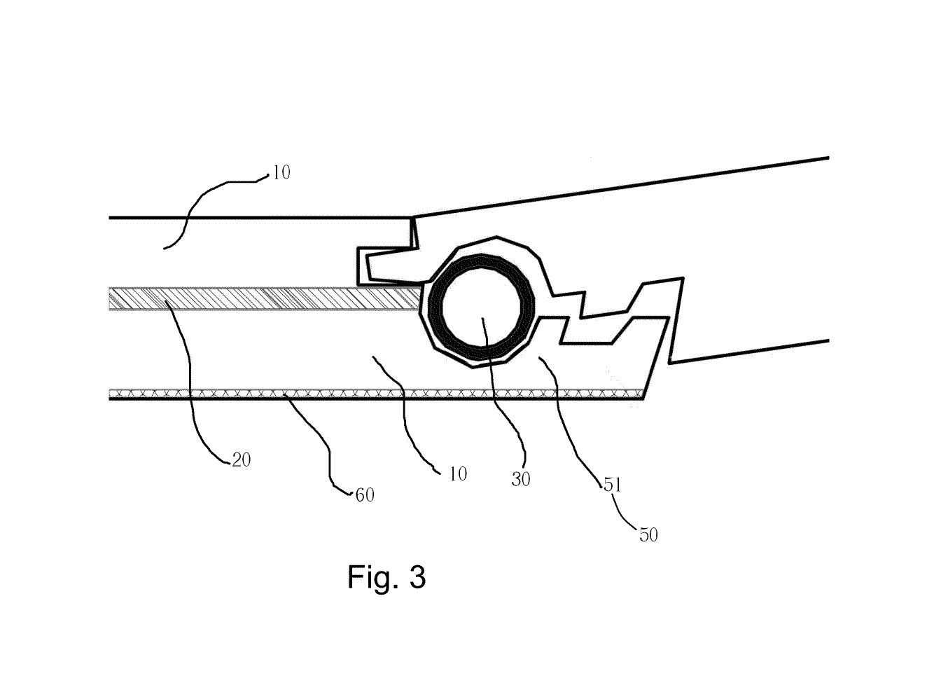

Referring to FIGS. 1 to 3 of the drawings, a ground heating flooring with internal heat conduction structure according to a preferred embodiment of the present invention is illustrated. The ground heating flooring comprises a flooring body 10, a plurality of heat conduction mediums 20, a heating pipe 30, an upper locking member 40 and a lower locking member 50.

Each of the heat conduction mediums 20, provided within the flooring body 10, one end of which contacts with the heating pipe 30, in such a manner that a heat within the heating pipe 30 is conducted directly and distributed rapidly all around the flooring to prevent the heat out of the flooring.

The upper locking member 40, provided at a side of the flooring body 10, defines an upper protruding supporting cavity 41. The lower locking member 50, provided at an opposite side of the flooring body 10, defines a lower concaved supporting cavity 51, wherein the heating pipe 30 is provided transversely within the lower concaved supporting cavity 51. When an upper locking member 40 of a flooring is engaged with a lower locking member 50 of an adjacent flooring, the upper protruding supporting cavity 41 is fitted into the lower concaved supporting cavity 51 for forming an accommodating chamber to receive the heating pipe 30 therein so that the heating pipe 30 is inserted into two adjacent floorings. As a result, a heat is conducted directly from the heating pipe 30 to each of the heat conduction mediums 20, and distributed rapidly all round of the flooring so as to increase effectively a temperature of the flooring to avoid the heat loss out of the flooring. Furthermore, the heating pipe 30 is inserted into two adjacent floorings to reduce a pavement thickness of the flooring.

Furthermore, the upper locking member 40 is F-shaped, a vertical cross-section of which is downwards thwart F-shaped. Accordingly, the lower locking member 50 is F-shaped, a vertical cross-section of which is upwards thwart F-shaped, in such a manner that the upper locking member 40 of a flooring is engaged with the lower locking member 50 of an adjacent flooring during a flooring procedure to sufficiently position the heating pipe 30 within the accommodating chamber and lock up two adjacent ground heating floorings.

Furthermore, each of the heat conduction mediums 20 is aligned with each other to conduct the heat directly from the heating pipe 30 to each of the heat conduction mediums 20, and distributed rapidly all round of the flooring so as to increase effectively a temperature of the flooring to avoid the heat loss out of the flooring.

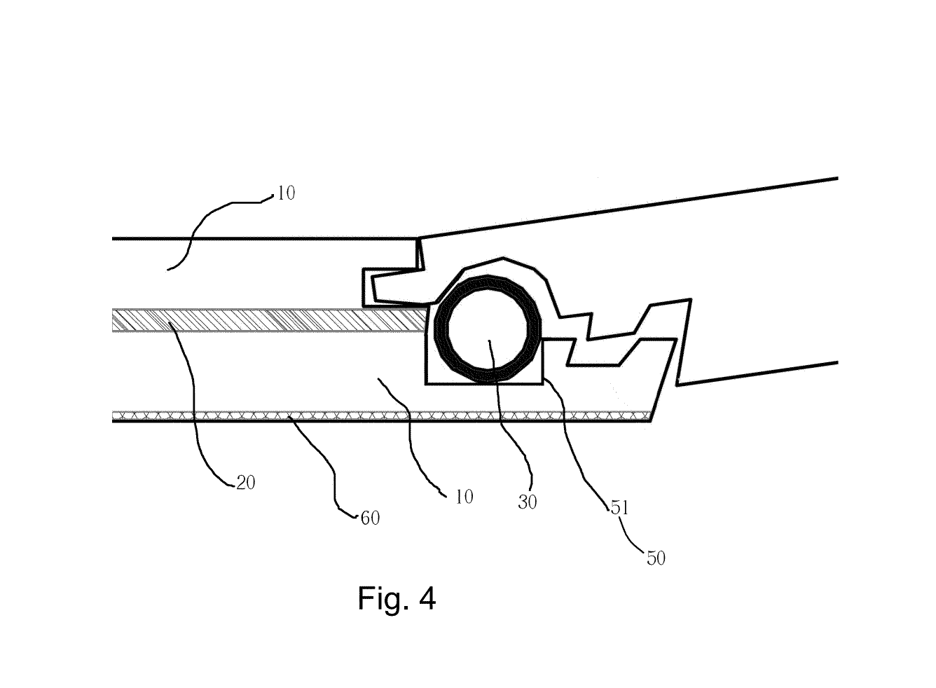

It is worth to mention that the upper protruding supporting cavity 41 and the lower concaved supporting cavity 51 can be arched, square, trapezoidal or the like, as shown in FIG. 4.

Furthermore, the ground heating flooring further comprises a heat insulation layer 60 provided at a bottom of the flooring body 10 and the lower locking member 50 to reduce a heat loss.

In the above preferred embodiment of the present invention, each of the heat conduction mediums 20 consists of Nanometer Aluminum Nitride powder, Nanometer Carbon Fiber powder and resin, or consists of a wire, net or slice made of metal or alloy, and resin. Also, each of the heat conduction mediums can be other materials with good thermal conductivity.

In the above preferred embodiment of the present invention, the heat insulation layer 60, made of porous silicon dioxide insulation composite, consists of SiO₂, TiO₂, Al₂O₃, Fe₂O₃, FeO, MnO₃, CaO, MgO, K₂O, and Na₂O. Also, the heat insulation layer is made of other composite materials with good thermal insulation property.

In the above preferred embodiment of the present invention, the ground heating flooring with internal heat conduction structure without thermal insulation materials having harmful chemical components, such as a polystyrene board, reduces the volatilization of harmful substance to provide a fine environment.

Furthermore, the ground heating flooring has a small pavement thickness to comfort the interior space. A pavement thickness of the traditional ground heating flooring is 7-8 cm, but that of the present invention is 1.5-2 cm.

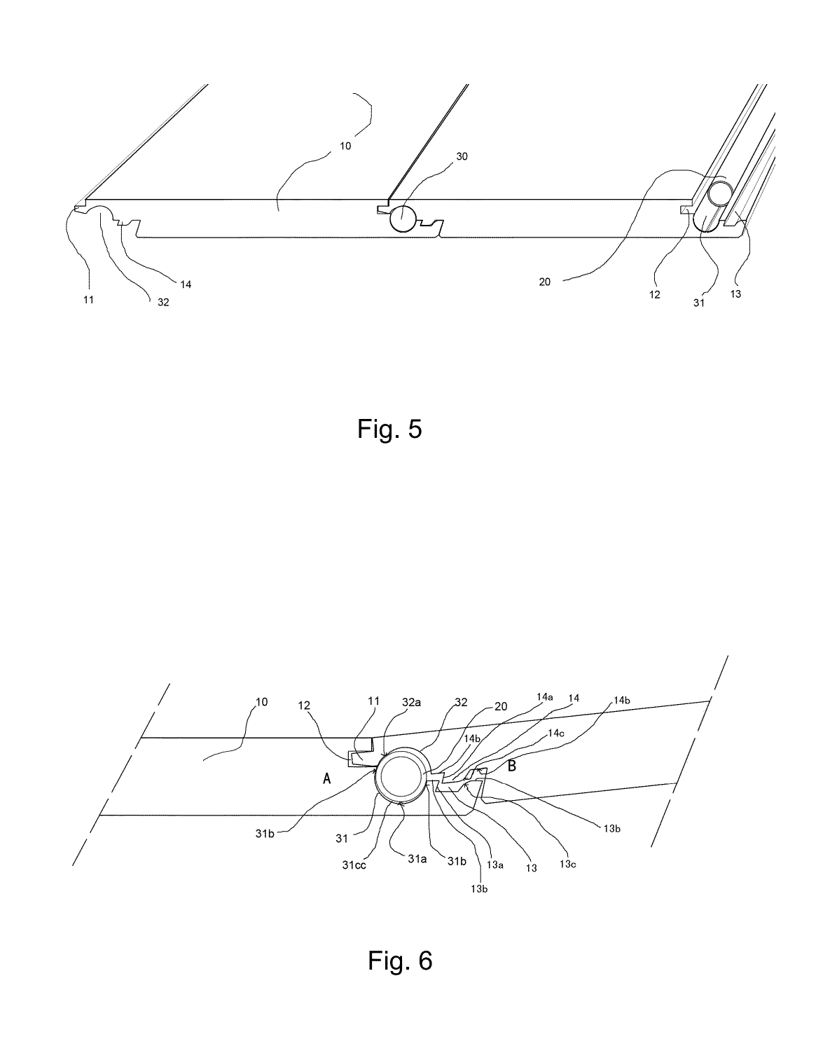

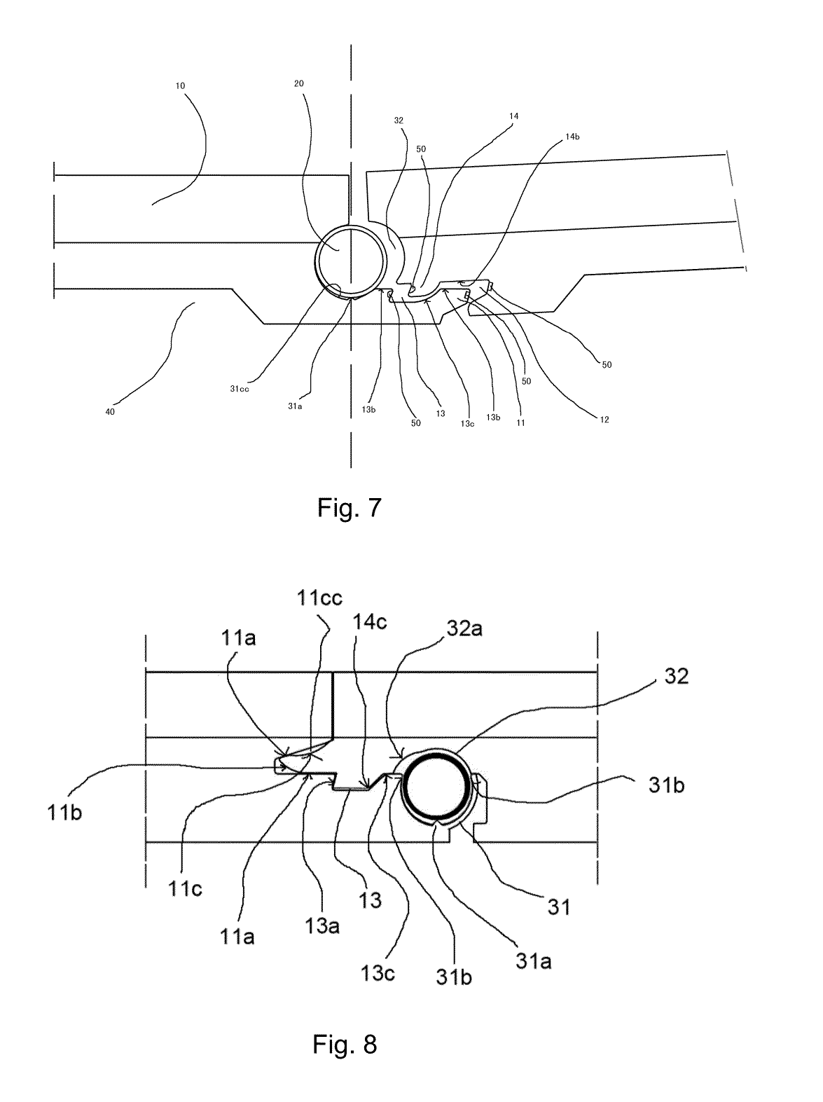

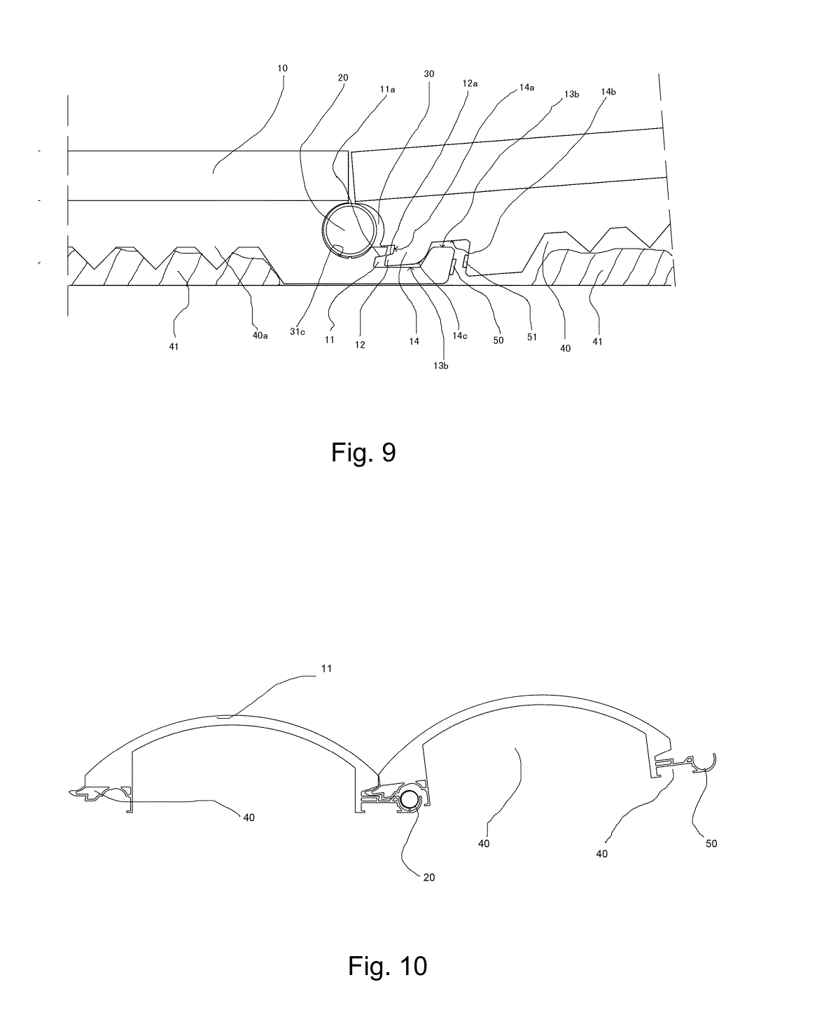

Referring to FIG. 5, FIG. 8 and FIG. 9, a buckle-connecting multifunctional decorative board, comprises:

a decorative board body 10, comprising a surface layer and a base;

an embedding tenon 11 and an embedding groove 12, respectively provided at two sides of the decorative board body 10;

first and second horizontal position limiting buckles 13, 14, respectively provided at the two sides of the decorative board body 10, and cooperatively defining an up-down supporting structure; and

first and second receiving grooves 31, 32, provided at the two sides of the decorative board body 10, matching with each other, having longitudinal openings, and cooperatively defining a receiving chamber 30;

wherein the decorative board body 10 has a filling space 40 provided in a bottom thereof, the filling space is concave;

a pipe or a cable 20 is received in the receiving chamber, wherein the pipe is used as or comprises a heating element, a cooling element, and the cable is a power transmitting element or a signal transmitting element;

the embedding tenon 11 is convex in general, the embedding groove 12 is concave in general, the embedding tenon 11 and the embedding groove 12 match with each other, in such a manner that one embedding tenon 11 of a decorative board body engages with one embedding groove 12 of an adjacent decorative board body;

the embedding tenon 11 has a first inclined plane 11a, the embedding groove 12 has a second inclined plane 12a matching with the first inclined plane 11a; when the embedding tenon 11 engages with the embedding groove 12, the first inclined plane 11a is pressed against the second inclined plane 12a to support the embedding groove 12 which has a hollow structure;

a section of the embedding tenon 11 has a front end in a shape of a peak, in such a manner that available space between the embedding tenon 11 and the embedding groove 12 is increased, and the embedding tenon 11 is able to enter the embedding groove 12 more easily, when the decorative board bodies 10 are assembled;

the embedding tenon 11 further has a concave 11c provided on a upper surface thereof, in such a manner that a top space 11cc is formed to further increase available space; thus, a position of the decorative board body 10 is able to be adjusted to avoid that sides and corners of the decorative boards collide with each other;

the first and second horizontal position limiting buckles 13, 14 respectively have side walls 13a, 14a which are inclined, and first and second horizontal locating planes 13b, 14b; when the first horizontal position limiting buckle 13 and the second horizontal position limiting buckle 14 engage with each other, and the embedding tenon 11 and the embedding groove 12 for limiting up-down position engage with each other, the two side walls 13a, 14a limit horizontal movement of the decorative boards, in such a manner that adjacent decorative boards are connected tightly to form a whole; the side walls 13a holds the second horizontal position limiting buckle 14 and the decorative board body 10, in such a manner that splitting between adjacent decorative boards due to shrink of materials is avoided, and assembling distances between end faces of the decorative boards are controlled; in addition, the first and second horizontal locating planes 13b, 14b bear weights of objects on the decorative board body 10, in such a manner that inner structures of the decorative boards are more stable; meanwhile, the first and second horizontal position limiting buckles 13, 14 has an effect of sealing, the first and second horizontal position limiting buckles 13, 14 prevent humidity from entering the decorative boards to cause damage;

when the first and second horizontal position limiting buckles 13, 14 engage with each other, the first and second receiving grooves 31, 32, provided at the two sides of the decorative board body 10 and having corresponding openings, cooperate to define the receiving chamber 30, the receiving chamber 30 receives the pipe 20, in such a manner that energy in the pipe 20 is transmitted to the decorative board body 10, and then spread to surfaces of the decorative board; thus, temperature of the decorative board is changed, heat radiates to indoor space; the first and second receiving grooves 31, 32 have sections in shape of arc, and the arc of the first receiving groove 31 is longer than the arc of the second receiving groove 32.

Referring to FIG. 5 and FIG. 8, when the embedding tenon 11 and the embedding groove 12 engage with each other, and the first and second horizontal position limiting buckles 13, 14 engage with each other, the first and second receiving grooves 31, 32, provided at the two sides of the decorative board body 10 and having corresponding openings, cooperate to define the receiving chamber 30. If the opening of the first receiving groove 31 is upward, the opening of the second receiving groove 32 is downward. If the opening of the first receiving groove 31 is leftward, the opening of the second receiving groove 32 is rightward. Preferably, the opening of the first receiving groove 31 is upward, in such a manner that the pipe 20 enters the first receiving groove 31 in a top-down direction. The first receiving groove 31 has a limiting bar 31b for preventing the pipe 20 which is curving and flexible from being out of the first receiving groove 31 and then disturbing assembly. Thus, the second receiving groove 32 is assembled conveniently. The second receiving groove 32 has at least one extending concave 32a provided at one side of the second receiving groove 32, for sparing a space for top portion of the pipe 20 in the first receiving groove 31, when the decorative board is assembled in a certain angle, in such a manner that assembling the decorative board becomes more convenient. In addition, the extending concave 32a also spares space for adjusting vertical position of the decorative board, to avoid collision between the decorative boards, and simplify assembling of the decorative board.

Referring to FIG. 6, the first side wall 13a, close to an opening, helps the second horizontal position limiting buckle 14 to insert in the first horizontal position limiting buckle 13 in a certain angle. When the first horizontal locating plane 13b completely engages with the second horizontal locating plane 14b, assembling of the decorative board is finished.

Referring to FIG. 6, the first horizontal position limiting buckle 13 has a leading cambered surface 13c provided in a top portion thereof, and the leading cambered surface 13c is streamlined. The second horizontal position limiting buckle 14 has a leading cambered surface 14c provided in a bottom portion thereof, and the leading cambered surface 14c is streamlined. Therefore, convex portion of the second horizontal position limiting buckle 14 is easy to enter and get out of concave portion of the first horizontal position limiting buckle 13, and extrusion force between the side walls 13a, 14a is decreased to protect the decorative board from damage.

The pipe 20 is for transmitting medium, and the medium is usually water.

Referring FIG. 9, surface layer of the decorative board is made of tile or marble. The filling space 40 is provided in the bottom of the decorative board body for filling adhesive 41, such as foam cement, foam glue, and cement mixing materials 41. When the decorative board achieves a certain height, an operator knocks another end of the decorative board gently to compact the adhesive, in such a manner that the decorative board adheres to ground or wall tightly. The decorative board is applicable for rough ground, because the filling space 40 is able to eliminate height difference and simplify construction process. Further, a plurality of bars 40a having sections in shape of triangle are provided on a surface of the bottom of the decorative board, in such a manner that contact area is increased when compacting the decorative board, and the bottom is easier to press into the adhesive 41 because of sharp angles of the bars, to contact with the adhesive 41 fully. The bars 40a is made of thermal insulation material, such as EPS foam resin board and magnesium oxide foam board. Therefore, parts of the decorative board are easy to manufacture, and the bar has strong resistance to pressure to prevent the ground from collapse due to aging of materials.

Referring to FIG. 9, a pair of magnets 50, 51 having mutual attraction are respectively provided at the two sides of the decorative board body 10, in such a manner that the magnet pulls the decorative board and further drives the embedding tenon 11 to get close to the embedding groove 12, until the first inclined plane 11a engages with the second inclined plane 12a. Then, assembling of the decorative board is finished.

Referring to FIG. 7˜9, the first receiving groove 31 comprises a stud 31a provided at a bottom thereof for jacking up the pipe 20 received in the first receiving groove 31, in such a manner that an interspace 31cc is formed, and contact area between the pipe 20 and the decorative board body is decreased. An aluminum foil reflecting film 31c is coated on surface of the bottom of the first receiving groove 31 for reflecting energy back to the pipe 20, reducing heat loss, and further saving energy. The interspace 31cc is for leading condensate water on a wall of the first receiving groove 31 to flow to an edge of the decorative board, and then flow out of the decorative board body 10, in such a manner that the decorative board is protected.

The stud 31a comprises a heat tracing cable provided therein for heating the pipe 20. Thus, a problem of frozen liquid in the pipe 20 is solved. When the decorative board is used outdoors, temperature of liquid will be decreased at end of the pipe 20, because the pipe 20 is long. The liquid may be even frozen and hard to melt, which will cause damage to the pipe 20; and the heat tracing cable protects the pipe 20 from the damage.

Referring to FIG. 5 and FIG. 10, the decorative board body 10 is in a shape of board or other shape 11, such as shape of tile, which is applicable for outdoor roof. The decorative board body 10 has a longitudinal chamber in any shape provided therein for insulating heat, in such a manner that manufacturing materials are saved.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A buckle-connecting multifunctional decorative board, comprising:
a decorative board body (10), comprising a surface layer and a base;
an embedding tenon (11) and an embedding groove (12) respectively provided at two sides of said decorative board body (10);
first and second horizontal position limiting buckles (13, 14) respectively provided at said two sides of said decorative board body (10), and cooperatively defining a up-down supporting structure; and
first and second receiving grooves (31, 32), provided at said two sides of said decorative board body (10), matching with each other, having longitudinal openings, and cooperatively defining a receiving chamber (30);
wherein said decorative board body (10) has a filling space (40) provided in a bottom thereof, said filling space (40) is concave;
a pipe or a cable (20) is received in said receiving chamber (30), wherein said pipe comprises a heating element, a cooling element, and said cable is a power transmitting element or a signal transmitting element;
said embedding tenon (11) is convex in general, said embedding groove (12) is concave in general, said embedding tenon (11) and said embedding groove (12) match with each other, in such a manner that one embedding tenon (11) of a decorative board body engages with one embedding groove (12) of an adjacent decorative board body;
said embedding tenon (11) has a first inclined plane (11a), said embedding groove (12) has a second inclined plane (12a) matching with said first inclined plane (11a), when said embedding tenon (11) engages with said embedding groove (12), said first inclined plane (11a) is pressed against said second inclined plane (12a) to support said embedding groove (12) which has a hollow structure;
a section of said embedding tenon (11) has a front end in a shape of a peak, in such a manner that available space between said embedding tenon (11) and said embedding groove (12) is increased, and said embedding tenon (11) is able to enter said embedding groove (12) more easily, when said decorative board bodies (10) are assembled;
said embedding tenon (11) further has a concave (11c) provided on an upper surface thereof, in such a manner that a top space (11cc) is formed to further increase available space, thus, a position of said decorative board body (10) is able to be adjusted to avoid that sides and corners of said decorative boards collide with each other;
said first and second horizontal position limiting buckles (13, 14) respectively have first and second side walls (13a, 14a) which are inclined, and first and second horizontal locating planes (13b, 14b); when said first horizontal position limiting buckle (13) and said second horizontal position limiting buckle (14) engage with each other, and said embedding tenon (11) and said embedding groove (12) for limiting up-down position engage with each other, said two side walls (13a, 14a) limit horizontal movement of said decorative boards, in such a manner that adjacent decorative boards are connected tightly to form a whole; said first side walls (13a) holds said second horizontal position limiting buckle (14) and said decorative board body (10), in such a manner that splitting between adjacent decorative boards due to shrink of materials is avoided, and assembling distances between end faces of said decorative boards are controlled; in addition, said first and second horizontal locating planes (13b, 14b) bear weights of objects on said decorative board body (10), in such a manner that inner structures of said decorative boards are more stable; meanwhile, said first and second horizontal position limiting buckles (13, 14) have an effect of sealing, said first and second horizontal position limiting buckles (13, 14) prevent humidity from entering said decorative boards to cause damage;
when said first and second horizontal position limiting buckles (13, 14) engage with each other, said first and second receiving grooves (31, 32), provided at said two sides of said decorative board body (10) and having corresponding openings, cooperate to define said receiving chamber (30), said receiving chamber (30) receives said pipe (20), in such a manner that energy in said pipe (20) is transmitted to said decorative board body (10), and then spreads to surfaces of said decorative board; thus, temperature of said decorative board is changed, heat radiates to indoor space; said first and second receiving grooves (31, 32) have sections in shape of arc, and said arc of said first receiving groove (31) is longer than said arc of said second receiving groove (32).

2. The buckle-connecting multifunctional decorative board, as recited in claim 1, wherein when said embedding tenon (11) and said embedding groove (12) engage with each other, and said first and second horizontal position limiting buckles (13, 14) engage with each other, said first and second receiving grooves (31, 32), provided at said two sides of said decorative board body (10) and having corresponding openings, cooperate to define said receiving chamber (30); when said opening of said first receiving groove (31) is upward, said opening of said second receiving groove (32) is downward; when said opening of said first receiving groove (31) is leftward, said opening of said second receiving groove (32) is rightward; when said opening of said first receiving groove (31) is upward, said pipe (20) enters said first receiving groove (31) in a top-down direction; said first receiving groove (31) has a limiting bar (31b) for preventing said pipe (20) which is curving and flexible from being out of said first receiving groove (31) and then disturbing assembly, thus, said second receiving groove (32) is assembled conveniently; said second receiving groove (32) has at least one extending concave (32a) provided at an inner surface of said second receiving groove (32), for sparing a space for a top portion of said pipe (20) in said first receiving groove (31) when said decorative board is assembled in a certain angle, in such a manner that assembling said decorative board becomes more convenient; in addition, said extending concave (32a) also spares space for adjusting vertical position of said decorative board, to avoid collision between said decorative boards and simplify assembling of said decorative board.

3. The buckle-connecting multifunctional decorative board, as recited in claim 1, wherein said first side wall (13a) is close to an opening, which helps said second horizontal position limiting buckle (14) to enter said first horizontal position limiting buckle (13) in a certain angle; when said first horizontal locating plane (13b) completely engages with said second horizontal locating plane (14b), assembling of said decorative board is finished.

4. The buckle-connecting multifunctional decorative board, as recited in claim 2, wherein said first side wall (13a) is close to an opening, which helps said second horizontal position limiting buckle (14) to enter said first horizontal position limiting buckle (13) in a certain angle; when said first horizontal locating plane (13b) completely engages with said second horizontal locating plane (14b), assembling of said decorative board is finished.

5. The buckle-connecting multifunctional decorative board, as recited in claim 1, wherein said first horizontal position limiting buckle (13) has a leading cambered surface (13c) provided in a top portion thereof, said leading cambered surface (13c) is streamlined, said second horizontal position limiting buckle (14) has a leading cambered surface (14c) provided in a bottom portion thereof, said leading cambered surface (14c) is streamlined, therefore, a convex portion of said second horizontal position limiting buckle (14) is easy to enter and get out of a concave portion of said first horizontal position limiting buckle (13), and extrusion force between said side walls (13a, 14a) is decreased to protect said decorative board from damage.

6. The buckle-connecting multifunctional decorative board, as recited in claim 2, wherein said first horizontal position limiting buckle (13) has a leading cambered surface (13c) provided in a top portion thereof, said leading cambered surface (13c) is streamlined, said second horizontal position limiting buckle (14) has a leading cambered surface (14c) provided in a bottom portion thereof, said leading cambered surface (14c) is streamlined, therefore, a convex portion of said second horizontal position limiting buckle (14) is easy to enter and get out of a concave portion of said first horizontal position limiting buckle (13), and extrusion force between said side walls (13a, 14a) is decreased to protect said decorative board from damage.

7. The buckle-connecting multifunctional decorative board, as recited in claim 1, wherein said pipe (20) is for transmitting medium, and said medium is water.

8. The buckle-connecting multifunctional decorative board, as recited in claim 2, wherein said pipe (20) is for transmitting medium, and said medium is water.

9. The buckle-connecting multifunctional decorative board, as recited in claim 1, wherein surface layer of said decorative board is made of tile or marble; said filling space (40) is provided in said bottom of said decorative board body (10) for filling adhesive (41) comprising foam cement, foam glue, or cement mixing materials; when said decorative board achieves a certain height, an operator knocks another end of said decorative board gently to compact said adhesive (41), in such a manner that said decorative board adheres to ground or wall tightly; said decorative board is applicable for rough ground, because said filling space (40) is able to eliminate height difference and simplify construction process; further, a plurality of bars (40a) having sections in shape of triangle are provided on a surface of said bottom of said decorative board, in such a manner that contact area is increased when compacting said decorative board; because said bars have sharp angles, said bottom is easier to press into said adhesive (41) to contact with said adhesive (41) fully; said bars (40a) is made of thermal insulation material, comprising EPS foam resin board or magnesium oxide foam board, therefore, parts of the decorative board are easy to manufacture, and said bar has strong resistance to pressure to prevent the ground from collapse due to aging of materials.

10. The buckle-connecting multifunctional decorative board, as recited in claim 2, wherein surface layer of said decorative board is made of tile or marble; said filling space (40) is provided in said bottom of said decorative board body (10) for filling adhesive (41) comprising foam cement, foam glue, or cement mixing materials; when said decorative board achieves a certain height, an operator knocks another end of said decorative board gently to compact said adhesive (41), in such a manner that said decorative board adheres to ground or wall tightly; said decorative board is applicable for rough ground, because said filling space (40) is able to eliminate height difference and simplify construction process; further, a plurality of bars (40a) having sections in shape of triangle are provided on a surface of said bottom of said decorative board, in such a manner that contact area is increased when compacting said decorative board; because said bars have sharp angles, said bottom is easier to press into said adhesive (41) to contact with said adhesive (41) fully; said bars (40a) is made of thermal insulation material, comprising EPS foam resin board or magnesium oxide foam board, therefore, parts of the decorative board are easy to manufacture, and said bar has strong resistance to pressure to prevent the ground from collapse due to aging of materials.

11. The buckle-connecting multifunctional decorative board, as recited in claim 1, wherein a pair of magnets (50, 51) having mutual attraction are respectively provided at said two sides of said decorative board body (10), in such a manner that said magnet pulls said decorative board and further drives said embedding tenon (11) to get close to said embedding groove (12) until said first inclined plane (11a) engages with said second inclined plane (12a), and then assembling of said decorative board is finished.

12. The buckle-connecting multifunctional decorative board, as recited in claim 2, wherein a pair of magnets (50, 51) having mutual attraction are respectively provided at said two sides of said decorative board body (10), in such a manner that said magnet pulls said decorative board and further drives said embedding tenon (11) to get close to said embedding groove (12) until said first inclined plane (11a) engages with said second inclined plane (12a), and then assembling of said decorative board is finished.

13. The buckle-connecting multifunctional decorative board, as recited in claim 1, wherein said first receiving groove (31) comprises a stud (31a) provided at a bottom thereof for jacking up said pipe (20) received in said first receiving groove (31), in such a manner that an interspace (31cc) is formed, and a contact area between said pipe (20) and said decorative board body is decreased; an aluminum foil reflecting film (31c) is coated on surface of said bottom of said first receiving groove (31) for reflecting energy back to said pipe (20), reducing heat loss, and further saving energy; said interspace (31cc) is for leading condensate water on a wall of said first receiving groove (31) to flow to an edge of said decorative board, and then flow out of said decorative board body (10), in such a manner that said decorative board is protected.

14. The buckle-connecting multifunctional decorative board, as recited in claim 2, wherein said first receiving groove (31) comprises a stud (31a) provided at a bottom thereof for jacking up said pipe (20) received in said first receiving groove (31), in such a manner that an interspace (31cc) is formed, and a contact area between said pipe (20) and said decorative board body is decreased; an aluminum foil reflecting film (31c) is coated on surface of said bottom of said first receiving groove (31) for reflecting energy back to said pipe (20), reducing heat loss, and further saving energy; said interspace (31cc) is for leading condensate water on a wall of said first receiving groove (31) to flow to an edge of said decorative board, and then flow out of said decorative board body (10), in such a manner that said decorative board is protected.

15. The buckle-connecting multifunctional decorative board, as recited in claim 13, wherein said stud (31a) comprises a heat tracing cable provided therein for heating; thus, a problem of frozen liquid in said pipe (20) is solved; when said decorative board is used outdoors, a temperature of liquid will be decreased at end of said pipe (20), because said pipe (20) is long; the liquid may be even frozen and hard to melt, which will cause damage to said pipe (20); and said heat tracing cable protects said pipe (20) from the damage.

16. The buckle-connecting multifunctional decorative board, as recited in claim 14, wherein said stud (31a) comprises a heat tracing cable provided therein for heating; thus, a problem of frozen liquid in said pipe (20) is solved; when said decorative board is used outdoors, a temperature of liquid will be decreased at end of said pipe (20), because said pipe (20) is long; the liquid may be even frozen and hard to melt, which will cause damage to said pipe (20); and said heat tracing cable protects said pipe (20) from the damage.

17. The buckle-connecting multifunctional decorative board, as recited in claim 1, wherein said decorative board body (10) is in a shape of board or other shape comprising a shape of tile, which is applicable for outdoor roof; the decorative board body (10) has a longitudinal chamber in any shape provided therein for insulating heat, in such a manner that manufacturing materials are saved.

18. The buckle-connecting multifunctional decorative board, as recited in claim 2, wherein said decorative board body (10) is in a shape of board or other shape comprising a shape of tile, which is applicable for outdoor roof; the decorative board body (10) has a longitudinal chamber in any shape provided therein for insulating heat, in such a manner that manufacturing materials are saved
